(19) United States
(12) Patent Application Publication
(10) Pub. No.: US 2007/0193432 A1
(43) Pub. Date: Aug. 23, 2007

(54) HOOP BODY APPARATUS

(76) Inventor: Ronn Dunnett, Delta (CA)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 11/677,996

(22) Filed: Feb. 22, 2007

Related U.S. Application Data
(60) Provisional application No. 60/776,621, filed on Feb. 23, 2006.

(51) Int. Cl. G10D 13/02

(52) U.S. Cl. 84/411 R

(57) ABSTRACT

A composite drum hoop. The composite drum hoop has a first body section. The first body section is configured to attach to a drum. A second body section attaches to the first body section. The second body section is arranged on the circular rim of the first body section to preserve the circular rim from a drumstick impact.

### RELATED APPLICATIONS

This application claims priority benefit of U.S. Ser. No. 60/776,621, filed Feb. 23, 2006.

### BACKGROUND

U.S. Pat. No. 6,166,311 discloses a drum hoop with protective edge. As seen in the Summary of the Invention section in column 2 around line 7, “The drum hoop of the present invention proposes to correct the deficiencies of the prior art drum assemblies by providing an inwardly directed edge to cover the bearing edge of the drum shell.” Further at line 12, “The drum hoop . . . has an inwardly directed edge which partially or substantially covers the top most bearing edge of the drum shell through the use of a rim which is beveled or which slightly tapers at its innermost point. The drum hoop serves to prevent damage to the bearing edge while also tensioning the drumhead to the drum shell.”

U.S. Pat. No. 5,261,309 discloses a wear pad assembly attachable to a drum structure. As seen in the Summary of the Invention section in column 1 around line 35, “The present drumstick wear pad assembly is attachable to a drum rim, and includes a nonmetallic relatively hard pad outwardly above the rim, the mount configured to be attachable to the drum structure in spaced relation to the rim.” Further down in the same column 1 around line 49, “The pad itself may advantageously consist of hard leather, closely acoustically coupled to the mount which is metallic and acoustically coupled to the rim, whereby drumstick striking of the pad transmits shock waves to the metallic rim to produce “rim shot” acoustic effect.”

U.S. Pat. No. 4,344,349 discloses a rim shot segment. As seen in the Summary of the Invention section in column 1 around line 33, “The present invention provides a new and improved arrangement for substantially eliminating all damage to drumsticks as a direct result of the rim shot technique while producing a more mellow, pleasant sound.” Further at line 37, “The present invention provides an attachment for a drum in the form of an arcuate segment of plastics material adapted to be secured with the drum head between the drum shell and drum hoop with the segment disposed in contact with the drum head and the inner circumferential surface of the hoop while extending above the hoop so as to prevent contact of the drumsticks with the metal hoop.”

### BRIEF DESCRIPTION OF THE DRAWINGS

FIG. 1A is a perspective view of the hoop body;

FIG. 1B is a perspective view of an alternative embodiment of the hoop body;

FIG. 2 is an elevational sectional view of the impact guard;

FIG. 3 is an elevational sectional view of an alternative embodiment of the impact guard;

FIG. 4A is perspective detail of the impact guard;

FIG. 4b is a perspective detail of an alternative embodiment of the impact guard;

FIG. 4C is a perspective detail of an alternative embodiment of the impact guard;

FIG. 4D is a perspective detail of an alternative embodiment of the impact guard;

FIG. 4E is a perspective detail of an alternative embodiment of the impact guard.

### EMBODIMENTS

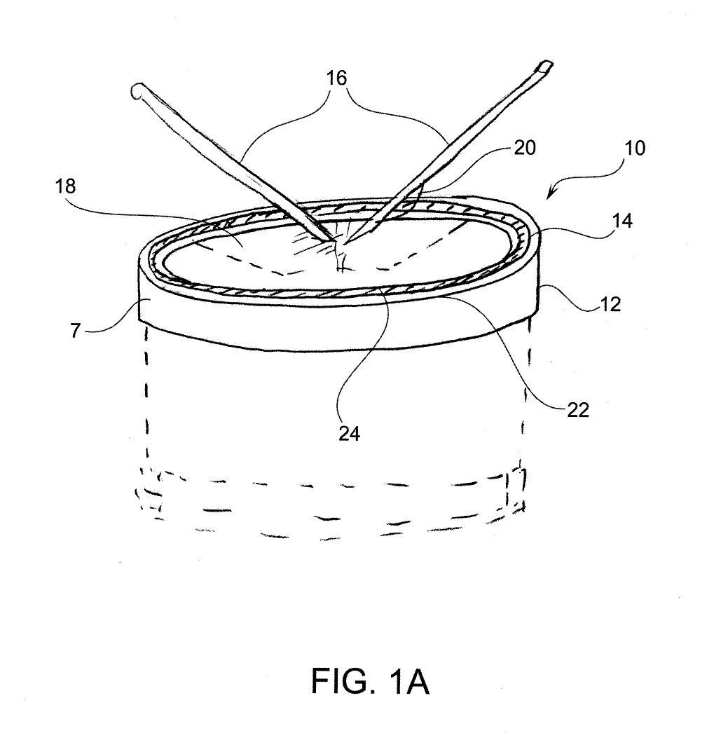

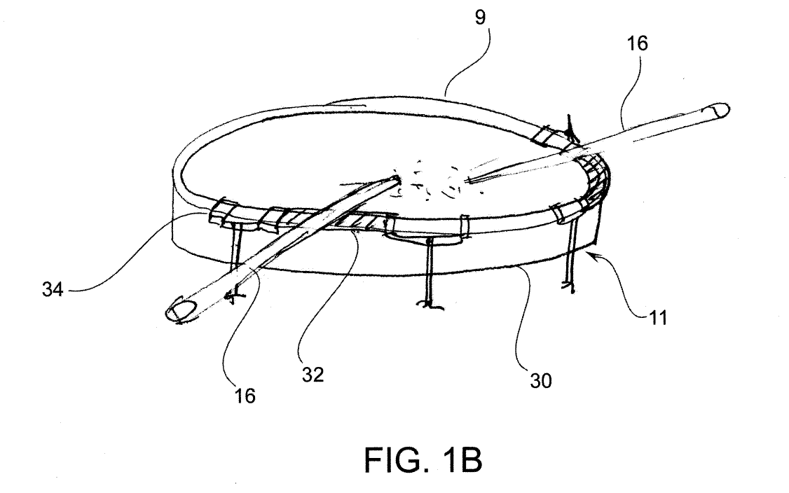

Referring to FIG. 1A, a hoop body impact protector 10, is provided to reduce wear and tear on hoop bodies 12 as well as to prevent wear and tear to the drumsticks 16 when the drumsticks 16 impact the inner hoop body radius corner 24 of the hoop body 12, the impact occurring within a stick impact zone 20. The hoop body itself can be constructed of various materials, including metal, wood, plastic or rubber; in one particular embodiment the hoop body is constructed of a laminated wooden ply construction, in an alternate construction it is a natural wood material.

The hoop body impact protector 10 and the hoop body 12 combine together to form a composite drum hoop 7. In general, the composite drum hoop has a first body section and a second body section. The first body section is the hoop body 12, and the second body section is the impact protector 10. Generally speaking, the first body section is arranged to attach to the drum, and the second body section is arranged to attach to the first body section.

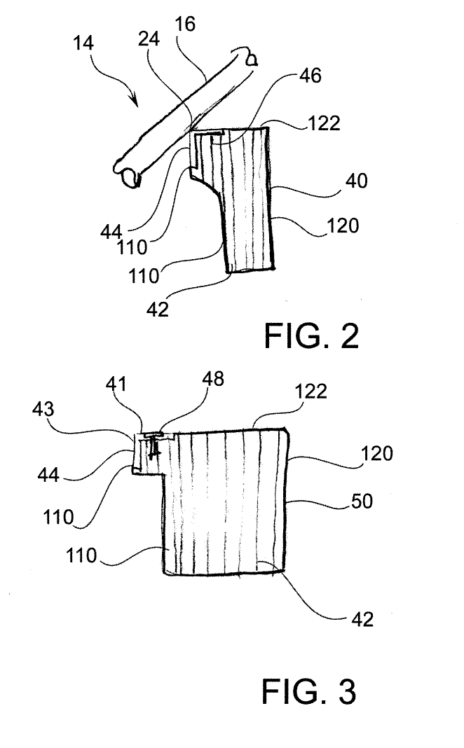

In most drum construction, the hoop body or first body section is a circular rim. The rims match the drum size and vary in diameter or radius depending on the size of the drum. Furthermore, the hoop body has a cross-sectional arrangement which also depends on the type of drum being used. For example, the hoop body 12 can be used for a snare drum, a bass drum or a tom-tom. The cross-section, as seen in FIGS. 2 and 3, can also vary. A narrow top hoop body 40, as seen in FIG. 2, is provided which has a narrower profile. A wide body hoop 50, as seen in FIG. 3, is also shown which has a wider profile than the narrow hoop body 40, as seen in FIG. 2. The narrow top hoop body section 40 and the wide top hoop body section 50 both have inner radial surfaces 110 and outer radial surfaces 120. Furthermore, each hoop body section has a top surface 122. Much of the impact will occur towards the inner radial surface on the top surface 122 of the various rims.

A first embodiment of the impact protector 10, as seen in FIG. 1A, is arranged to provide for protection of the hoop body 12 within the inner hoop radius 24. Here the entire interior circumferential edge of the hoop radius 24 is covered by the impact protector 10. In other words, a circular edge coverage is provided by the impact protector 10 in this first embodiment. In an embodiment where the hoop rim is made of a wooden construction and the impact protector 10 is constructed of a metallic material such as brass, the striking of the impact protector 10 with the drumsticks 16 creates a pleasing high frequency sound or rim shot.

A second embodiment of the impact protector 10, as seen in FIG. 1B, provides for a localized hoop body impact protector 11. The localized impact protector 11 essentially covers a portion of the circular edge coverage as indicated above, or in other words creates an arcuate edge coverage. This arcuate edge coverage can include a first arc or first partial circumferential impact guard 32, as well as a second arc or second partial circumferential impact guard 33.

In the bass drum embodiment, as seen in FIG. 1B, the partial impact guards are used to bridge between bass drum hoop claws 34 of the top hoop 30 of the bass drum. The bass drum top hoop body 30 in this embodiment is of a wooden construction. The hoop claws 34 connect together via the partial circumferential impact guards 32 and 33. Therefore, the user can place the partial circumferential impact guards 32 and 33 strategically about the circumference of the bass drum hoop body 30 so that the drum sticks 16 do not impact the top face 9 of the hoop body 30, thus preventing damage to both the hoop body and the drumsticks over long periods of use.

Referring to FIG. 2, one form of the impact guard 14 is provided on the inner radius 24 of a narrow wooden top hoop body 40. The impact guards 14 themselves are constructed of materials which have a high resistance to repetitive impacts; these types of materials include brass, steel, aluminum, carbon fiber, fiberglass, and rubber products such as butyl rubber or natural rubber. Other materials which would provide for lengthening of the life of the wooden hoop drum top body 12 (as seen in FIG. 1) would also include the use of plastics or polyvinyl chlorides fashioned in such a manner that the impact of the drumsticks 16 on the wooden hoop 12 would be minimized and the wooden top hoop 12 would be preserved while still enabling its aesthetic and musical characteristics.

Generally speaking, the protector cross section is arranged so that it can cover the top surface 122, as seen in FIG. 2, of the circular rim. The top surface 122 may be the top surface of a rectilinear shape, a circular shape, an oval shape, or any geometric cross sectional shape of the circular rim. While the protector cross section as provided in the embodiments currently provided, matches in some respects the surface of the circular rim, in alternative embodiments the protector cross section may have just one attachment point to the drum. This attachment point may be as indicated above, connected to the drum claws, connected to other portions of the drum structure, or the attachment point may be situated on the circular rim either periodically or continuously.

A discussion of the shapes of the impact guard in cross section will now be provided. While the current shapes in the impact guard are provided in alternative embodiments, it is conceived that the impact guard cross-sectional shape can be arranged in any fashion which provides the desired protection to the circular rim. For example, the impact guard may have a cross section which is circular, oval, rectilinear, non-rectilinear, amoeba like, or any other type of cross-sectional shape which substantially covers the desired protected area on the circular rim. Discussion of some of the alternative embodiments of the impact guard are referred to below.

Referring back to FIG. 2, one form of the impact guard 14 is an L-shaped impact guard 44; this L-shaped impact guard 44 can be attached to the narrow wooden top hoop body for the inner radius 24 by pressing the L-shaped impact guard 44 into the narrow wooden top hoop body 40 in somewhat of a press-on attachment means 46.

Another form of attachment for the L-shaped impact guard 44 would be through the use of (as seen in FIG. 3 a wooden or metal screw attachment 48 which would be attached to the top leg 41 or side leg 43 of the L-shaped impact guard 44. Also, as seen in FIG. 3, the wooden top hoop body 50 is in a wide-body configuration.

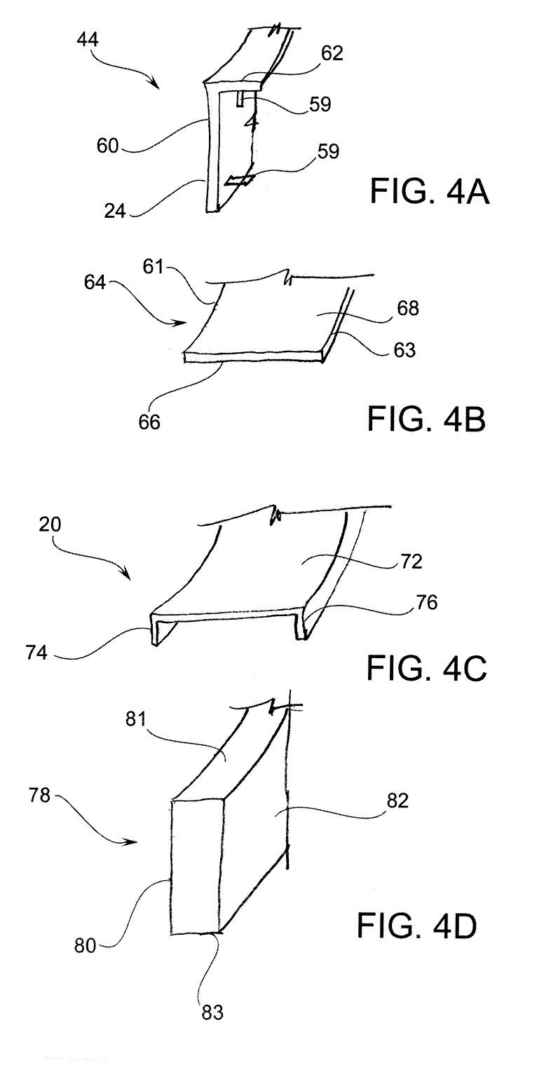

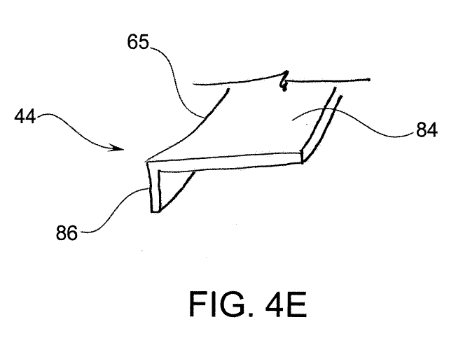

Another embodiment or configuration of the impact guard 14 would be in the arrangement of an L-shaped impact guard 44 as seen in FIG. 4A having a long vertical leg 60 arranged on the inside radius 24 of the wooden hoop body 12. The L-shaped impact guard 44 would also have a short horizontal leg 62. In a further attachment means, the L-shaped impact guard 44 has in this current embodiment plurality of attachment protrusions or attachment tabs 59 which anchor the impact guard to the wooden hoop body.

Another form of the impact guard 14 is through the use of a flat bar impact guard 64 as seen in FIG. 4B. This flat bar impact guard 64 is arranged on the top face 9 of the wooden hoop body 12 where the flat bar has a top horizontal face 68 and a bottom horizontal face 66. The flat bar 64 also has an inner radial edge 61 and an outer radial edge 63, each corresponding to the inner hoop radius edge 24 and the outer hoop radius edge 22 of the hoop body 12 respectively as seen in FIG. 1.

Another form of the impact guard 14 (as seen in FIG. 4C) is a U-shaped impact guard 70. This particular embodiment has a horizontal top leg 72, a vertical inner radial leg 74 which corresponds to the inner hoop radius 24, and a vertical outer radial leg 76 which corresponds to the outer hoop radius 22.

Referring to FIG. 4D, the vertically aligned flat bar impact guard 78 has an inner radius face 80 and an outer radius face 82, as well as a top face 81 and a bottom face 83. The top face 81 is arranged to take the impact of the drumsticks 16 as previously discussed.

Another form of the impact guard 14 is an L-shaped guard 44 (as seen in FIG. 4E) which has a long horizontal leg 84 and a vertical short leg 86. The long horizontal leg 84 in this particular embodiment has the origin 85 of the two legs, corresponding to the inner hoop radius 24 of the hoop body.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

Therefore I claim:

1. A composite drum hoop comprising:
a. a first body section configured to attach to a drum;
b. a second body section configured to interoperate with said first body section;
c. said first body section further comprising a circular rim, a cross-section;
d. said second body section further comprising a first arcuate impact layer to preserve said circular rim from the impact of a drumstick.

2. The composite drum hoop according to claim 1, wherein said drum further comprises a tom-tom drum.

3. The composite drum hoop according to claim 1 wherein said drum further comprises a snare drum.

4. The composite drum hoop according to claim 1 wherein said drum further comprises a bass drum.

5. The composite drum hoop according to claim 1 wherein said circular rim further comprises an inner radial edge.

6. The composite drum hoop according to claim 1 wherein said cross section further comprises a circular cross section.

7. The composite drum hoop according to claim 1 wherein said cross section further comprises a rectilinear cross section.

8. The composite drum hoop according to claim 1 wherein said cross section further comprises an oval cross section.

9. The composite drum hoop according to claim 1 wherein said cross section further comprises a wide body cross section.

10. The composite drum hoop according to claim 1 wherein said cross section further comprises a narrow body cross section.

11. The composite drum hoop according to claim 1 wherein said first body section further comprises a wooden construction.

12. The composite drum hoop according to claim 1 wherein said first body section further comprises a wooden laminate ply construction.

13. The composite drum hoop according to claim 1 wherein said first body section further comprises a non-wooden construction.

14. The composite drum hoop according to claim 1 wherein said first body section further comprises a metallic material.

15. The composite drum hoop according to claim 1 wherein said first body section further comprises a plastic material.

16. The composite drum hoop according to claim 1 wherein said first body section further comprises a rubber material.

17. The composite drum hoop according to claim 1 wherein said second body section further comprises a protector cross section.

18. The composite drum hoop according to claim 17 wherein said protector cross section further comprises a substantially matching shape to said cross section.

19. The composite drum hoop according to claim 1 wherein said second body section further comprises an arcuate length to match a perimeter circumferential length portion of said first body section.

20. The composite drum hoop according to claim 19 wherein said arcuate length further comprises a first arcuate length, a second arcuate length, said first arcuate length matching a first portion of said perimeter circumferential length, said second arcuate length matching a second portion of said perimeter circumferential length.

21. The composite drum hoop according to claim 1 wherein said second body section further comprises an arcuate length to match a rim circumference of said first body section.

22. The composite drum hoop according to claim 17 wherein said protector cross section further comprises a rim coverage arrangement comprising a first attachment location, a substantially non-matching shape to said cross section.

23. The composite drum hoop according to claim 17 wherein said protector cross section further comprises an L-shape configuration.

24. The composite drum hoop according to claim 17 wherein said protector cross section further comprises a flat bar configuration.

25. The composite drum hoop according to claim 17 wherein said protector cross section further comprises a round bar configuration.

26. The composite drum hoop according to claim 17 wherein said protector cross section further comprises a U-shape configuration.

27. The composite drum hoop according to claim 23 wherein said L-shape configuration further comprises an equilateral leg arrangement.

28. The composite drum hoop according to claim 23 wherein said L-shape configuration further comprises an un-equilateral leg arrangement.

29. The composite drum hoop according to claim 23 wherein said L-shape configuration further comprises a first leg arranged to interoperate with a top surface of said first body section.

30. The composite drum hoop according to claim 23 wherein said L-shape configuration further comprises a second leg arranged to interoperate with an inner radial surface of said first body section.

31. The composite drum hoop according to claim 23 wherein said L-shape configuration further comprises a second leg arranged to interoperate with an outer radial surface of said first body section.

32. The composite drum hoop according to claim 1 wherein said second body section further comprises a high resistant material to repetitive impacts.

33. The composite drum hoop according to claim 1 wherein said second body section further comprises a brass material.

34. The composite drum hoop according to claim 1 wherein said second body section further comprises a steel material.

35. The composite drum hoop according to claim 1 wherein said second body section further comprises an aluminum material.

36. The composite drum hoop according to claim 1 wherein said second body section further comprises a carbon fiber material.

37. The composite drum hoop according to claim 1 wherein said second body section further comprises a fiberglass material.

38. The composite drum hoop according to claim 1 wherein said second body section further comprises a rubber material.

39. The composite drum hoop according to claim above wherein said second body section further comprises a second arcuate impact layer arranged to interact with said first arcuate impact layer.

40. A composite drum hoop comprising:
a. a first body section comprising a circular rim, said circular rim comprising a cross-section, said first body section configured to attach to a drum;
b. a second body section comprising a first arcuate impact layer, said second body section configured to attach to said first body section;
c. said first body section further comprising a wooden material;
d. said second body section further comprising a metallic material, an attachment means to maintain a connection between said first body section in said second body section;
e. said first arcuate impact layer interoperating with said circular rim and protecting said circular rim from a drumstick impact, said drumstick impact producing an impact sound.

41. A drum comprising:
a. a circular outer shell;
b. a bottom hoop;
c. a composite top hoop comprising;
i. a first body section comprising a circular rim, said circular rim comprising a cross-section, said first body section configured to attach to a drum;
ii. a second body section comprising a first arcuate impact layer, said second body section configured to attach to said first body section;
iii. said first body section further comprising a wooden material;
iv. said second body section further comprising a metallic material, an attachment means to maintain a connection between said first body section in said second body section;
v. said first arcuate impact layer interoperating with said circular rim and protecting said circular rim from a drumstick impact, said drumstick impact producing an impact sound.
